(19) United States
(12) Patent Application Publication
(10) Pub. No.: US 2012/0244299 A1
(43) Pub. Date: Sep. 27, 2012

(54) INSULATION APPARATUS

(76) Inventors: Carlos Colon, Rockledge, FL (US); Danny Parker, Cocoa Beach, FL (US)

(21) Appl. No.: 13/427,160

(22) Filed: Mar. 22, 2012

Related U.S. Application Data
(60) Provisional application No. 61/466,774, filed on Mar. 23, 2011.

(51) Int. Cl. F24H 9/02; B32B 1/06; B23P 11/00; B32B 3/24

(52) U.S. Cl. 428/34.1; 428/137; 29/428

(57) ABSTRACT

Herein disclosed are embodiments of an insulating device adapted for use with at least one heat source which may have at least one projection on an end thereof. In one embodiment, the insulating device includes a plurality of insulating cap modules. The modules may assemble together to form an insulating cap that substantially covers the end. Each of the insulating cap modules may have least one aperture that allows passage of the at least one projection when assembled. Further disclosed is a kit comprising an insulating device and a method of making an insulating device.

### FIELD

At least some embodiments relate to thermal insulation, more specifically water heater insulation.

### BACKGROUND

Containers and vessels for heated liquids must be insulated to prevent heat loss. Failure to insulate these containers results in a great expense due to the transfer of heat energy into the surrounding environment. Situations such as these, where heat energy is lost into the surrounding environment are commonly experienced, in both the residential as well as the commercial arena.

Insulation materials and devices for insulating water heaters, hot water pipes, and other containers and carrier means for the heating, storing, and conveyance of heated water and other liquids is known. In the past, devices for insulating hot water heaters, pipes, boilers and the like were made of asbestos, however, more recently many health problems caused by asbestos has discouraged its use. Currently, fiberglass is a preferred material for insulation, however fiberglass is typically shredded or provided for use in strands, and therefore it will not hold its shape. Moreover, if it comes in contact with human skin it can be hazardous and uncomfortable; therefore it is typically covered on its outer layer with another material such as paper, plastic or foil. These materials which typically surround fiberglass, however, are not resistant to ears, abrasions, or water damage, and therefore does not efficiently provide maximum insulation over a long period of use, as it loses its shape, and tends to sag, tear, deteriorate, ore fall off the container.

### SUMMARY

In one embodiment of the subject invention, there is provided an insulating device adapted for use with at least one heat source which may have at least one projection on an end thereof. The insulating device includes a plurality of insulating cap modules, wherein the modules assemble together to form an insulating cap that substantially covers the end in one embodiment. Each of the insulating cap modules may have at least one aperture that allows passage of the at least one projection when assembled.

In another embodiment, a kit for insulating a heat source having an insulating device adapted for use with at least one heat source which may have at least one projection on an end thereof is provided. The insulating device may have a plurality of insulating cap modules. The modules may assemble together to form an insulating cap that substantially covers the end. Each of the insulating cap modules may have at least one aperture that allows passage of the at least one projection when assembled.

In still another embodiment, there is provided a method for making an insulating device including the step of creating an insulating device adapted for use with at least one heat source having at least one projection on an end thereof. The insulating device includes a plurality of insulating cap modules. The insulating cap modules may assemble together to form an insulating cap that substantially covers the end of the heat source. Each of the plurality of insulating cap modules may include at least one aperture that allows passage of the at least one projection when assembled.

### BRIEF DESCRIPTION OF THE DRAWINGS

Some embodiments are better understood by reading the following Detailed Description, taken together with the Drawings, wherein,

FIG. 1A is a cross-sectional view of an embodiment of an insulating device in accordance with this Disclosure;

FIG. 1B is a 3-D view of an embodiment of an assembled insulating cap in accordance with this Disclosure; and

FIG. 1C is a cross-sectional view of an embodiment of an insulating cap in accordance with this Disclosure.

### DETAILED DESCRIPTION

The embodiments disclosed herein are described with reference to the attached figures, wherein like reference numerals are used throughout the figures to designate similar or equivalent elements. The figures are not drawn to scale and they are provided merely to illustrate the disclosed embodiments. Several aspects are described below with reference to example applications for illustration. It should be understood that numerous specific details, relationships, and methods are set forth to provide a full understanding of the disclosed embodiments. One having ordinary skill in the relevant art, however, will readily recognize that the subject matter disclosed herein can be practiced without one or more of the specific details or with other methods. In other instances, well-known structures or operations are not shown in detail to avoid obscuring structures or operations that are not well-known. This Disclosure is not limited by the illustrated ordering of acts or events, as some acts may occur in different orders and/or concurrently with other acts or events. Furthermore, not all illustrated acts or events are required to implement a methodology in accordance with this Disclosure.

Notwithstanding that the numerical ranges and parameters setting forth the broad scope of this Disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

For the purposes of promoting an understanding of the principles and operation of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to those skilled in the art to which the invention pertains.

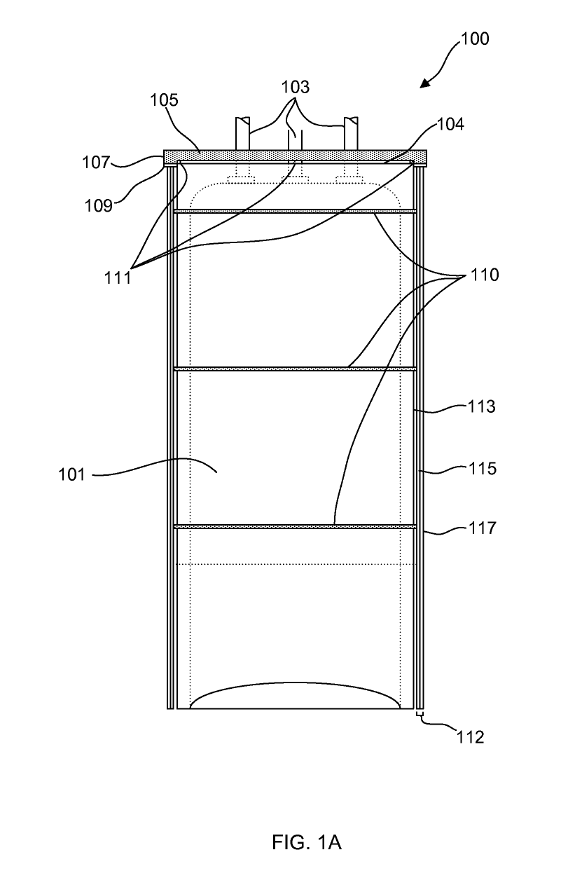

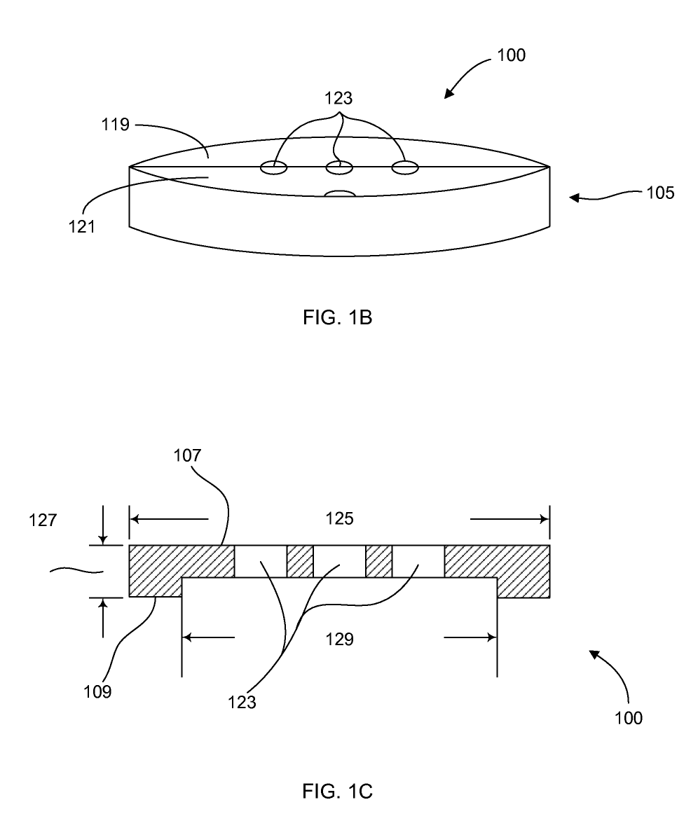

In at least some embodiments, referring to FIGS. 1A, 1B, and 1C, an insulating device 100 adapted for use with at least one heat source 101 is herein disclosed.

Referring to FIG. 1A, a heat source 101 may have at least one projection 103 on at least one end 104. In the case of a water heater, the at least one projection 103 may include a cold water pipe and/or a hot water pipe. In the case of a gas water heater, the projections 103 may also include a flue for exhaust gases to exit the heat source.

In some embodiments, referring to FIGS. 1B and 1C, an insulating device 100 has a plurality of insulating cap modules 119, 121. The modules 119, 121 may be assembled together to form an insulating cap 105 as shown in FIG. 1B to substantially cover an end 104 of the heat source 101.

In some embodiments, each of the insulating cap modules 119, 121 include at least one aperture 123 that allows passage of the at least one projection 103 when assembled. An aperture 123 may be a recess, hole, cut, or otherwise any area of removed material. In a particular embodiment, the at least one aperture 123 on each of the insulating cap modules 119, 121 align upon assembly as is shown in the embodiment of FIG. 1B.

The plurality of insulating cap modules 119, 121 may be any number of modules 119, 121 that assemble to form an insulating cap 105. In some embodiments, the insulating cap 105 is assembled from only two insulating cap modules 119, 121 as shown in FIG. 2. In some embodiments, the cap is assembled from more than two insulating cap modules 119, 121.

The insulating cap 105 may be of any shape, including annular shapes and non-annular shapes. The shape of the insulating cap 105 may be selected based on the type of heat source 101 to which the insulating cap 105 is to be adapted. Furthermore, the shape may also be selected based on desired aesthetic appeal. The insulating cap modules 119, 121 may be symmetric or asymmetric in shape and design, provided that the totality of insulating cap modules 119, 121 assemble to substantially form at least one insulating cap 105.

In some embodiments, the insulating cap 105 may further be described as having a body 107 and at least one flange member 109 extending from the body 107. The body 107 may define a first section of the insulating cap 105, and the flange 109 may define a second section of the insulating cap 105. In another embodiment, the body 107 of the insulating cap may be separate but connected to or associated with the flange 109. The body 107 and the at least one flange member 109 may take any shape such that they assemble together to form at least part of the insulating cap 105. Multiple shapes may be present in a single embodiment of the insulating cap 105.

As shown in FIG. 2, in some embodiments, the insulating cap may have a first dimension 125, a second dimension 127 and a third dimension 129. The dimensions may be any value necessary to fit a heat source.

In at least some embodiments where the heat source 101 is a water heater, the dimensions may be anything necessary to substantially cover at least an end 104 of the water heater. In some embodiments, the dimensions may be such that the at least one flange member 109 extends the length of the heat source 101 and beyond, if necessary, thus providing a side wrap 112 as well (see FIG. 1A).

In some embodiments, the first dimension 125 ranges from about 6″ to about 3′. The first dimension 125 may be approximately 1′-11″.

In some embodiments, the second dimension 127 ranges from about a half of an inch to about the length of the heat source 101. The second dimension 127 may be about 3″. The second dimension 127 may even be about 2.75″.

In some embodiments, the third dimension 129 ranges from about 6″ to about 3′. The third dimension 129 may be about 1′-7″.

The at least one flange member 109 may be integral on the body 107 such that it is substantially formed with or as part of the body 107.

The at least one flange member 109 may be disposed on the body 107 non-integrally such that it is removably or permanently attached using at least one adhesive, latch, or any other means suitable for connecting.

In some embodiments, at least one airspace creating spacer 111 may be integral on the body 107, and/or on the at least one flange member 109, or any combination thereof. In some embodiments, at least one air space creating spacer 111 may be connected integrally or non-integrally to the insulating cap 105. In at least some embodiments, when the at least one airspace creating spacer 111 is disposed thereon, either integrally or non-integrally, and the insulating cap 105 is placed on a heat source 101, the at least one airspace creating spacer 111 creates at least one pocket of air having a first thickness between the surface of the heat source 101 and the insulating cap 105.

The first thickness may range from about 0″ to about 12″. In some embodiments, the first thickness is ranges from about ¼″ to about 2″. The first thickness may be ½″.

The at least one an airspace creating spacer 111 may be disposed non-integrally on the body 107, the at least one flange member 109, on the heat source 101, or on any combination thereof, such that it is removably or permanently attached using at least one adhesive, latch, or any other means suitable for connecting.

The insulating device 100 herein disclosed may be made out of at least one material. The at least one material may be selected from a foam, bubble wrap, fiberglass, or any other insulation material. In some embodiments, at least one material may be selected so it has an R-Value of less than 8. In a particular embodiment, the at least one material comprises poly-iso foam.

The insulating device 100 may include a reflective surface on at least a portion of the insulating device 100. The reflective surface may be disposed on the side of the insulating cap 105 facing the heat source 101, an insulating cap module 119, 121, a body 107, a flange 109, at least one airspace creating spacer 111, or on any combination thereof. The reflective surface may be at least one thermally reflective coating, sheet of material, foil or any other thermally reflective enhancement.

Referring back to FIG. 1A, the insulating device 100 may further have at least one side wrap 112. The at least one side wrap 112 may have at least one insulation layer 117. In some embodiments, the side wrap 112 has at least one reflective layer 115 disposed on at least a portion of the at least one insulation layer 117. The at least one insulation layer 117 may be made of at least one material as described above. The at least one reflective layer 115 may be at least one thermally reflective coating, sheet of material, foil or any other thermally reflective enhancement.

In some embodiments, the insulating device 100 may have at least one airspace creating rib 110 which contact the at least one side wrap 112 in such a manner that it creates an airspace between the heat source 101 and the side wrap 112. The at least one airspace creating rib 110 may be integral to the side wrap 112 or may be connected to the side wrap 112 non-integrally. Furthermore, the at least one airspace creating rib 110 may be placed directly on the heat source 101 before any insulating cap 105 or side wrap 112 is used.

In a further embodiment, three or more airspace creating ribs 110 are provided as shown in FIG. 1A.

The at least one airspace creating rib 110 may be made from at least one material as described above. In some embodiments, the airspace creating rib 110 has a reflective surface as described above.

Further disclosed is a kit for insulating at least one heat source having at least one insulating cap module 119, 121 as described above. The kit may include two or more insulating cap modules 119, 121 as described above suitable to create an insulating cap 105 as described above. The kit may further have a side wrap 112 as described above. In some embodiments, the kit includes at least one airspace creating spacer 111 as described above. The kit may also include at least one airspace creating rib 110 as described above.

In some embodiments, the kit contains two insulating cap modules 119, 121 that assemble together to form an insulating cap 105. In some embodiments, the kit comprises at least two insulating cap modules 119, 121 as described above, at least one side wrap 112 as described above, at least one airspace creating spacer 111 as described above, and at least two airspace creating ribs 110 as described above.

Still further disclosed is a method for making an insulating device 100 including the steps of creating at least one insulating cap module 119, 121 as described above. The at least one insulating cap module 119, 121 may be created by molding, pouring, sculpting, or any other method as known in the art used to create such a device.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

Thus, the breadth and scope of the subject matter provided in this Disclosure should not be limited by any of the above explicitly described embodiments. Rather, the scope of this Disclosure should be defined in accordance with the following claims and their equivalents.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which embodiments of the invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. An insulating device adapted for use with at least one heat source having at least one projection on an end thereof, said insulating device comprising:
a plurality of insulating cap modules, wherein said modules assemble together to form an insulating cap that substantially covers said end, and wherein each of said modules comprises at least one aperture that allows passage of said at least one projection there through when the modules are assembled.

2. The insulating device of claim 1, wherein said cap comprises two insulating cap modules.

3. The insulating device of claim 1, wherein said insulating cap comprises an annular shape.

4. The insulating device of claim 1, wherein said insulating cap comprises a non-annular shape.

5. The insulating device of claim 1, wherein said insulating cap further comprises:
a body; and
at least one flange member extending from said body.

6. The insulating device of claim 5, wherein said at least one flange member is integral on said body.

7. The insulating device of claim 5, wherein said at least one flange member is connected non-integrally to said body.

8. The insulating device of claim 1, further comprising an airspace creating spacer disposed on said insulating cap.

9. The insulating device of claim 8, wherein said airspace creating spacer is disposed integrally with said insulating cap.

10. The insulating device of claim 1, further comprising at least one material, wherein said at least one material comprises polyiso foam.

11. The insulating device of claim 1, wherein said at least one aperture on each of said insulating cap modules align upon assembly.

12. The insulating device of claim 1, wherein said at least one heat source comprises at least one water heater.

13. The insulating device of claim 12, wherein said at least one protrusion comprises at least one pipe of said at least one water heater.

14. The insulating device of claim 12, wherein said at least one water heater is a gas water heater and said at least one protrusion further comprises a gas water heater flue.

15. The insulating device of claim 1, wherein at least one of said insulating cap modules further comprises at least one reflective surface on at least a portion of at least one of said insulating cap modules.

16. A kit for insulating at least one heat source, comprising:
an insulating device adapted for use with said at least one heat source, said at least one heat source comprising at least one projection on an end thereof, said insulating device comprising a plurality of insulating cap modules,
wherein said plurality of insulating cap modules assemble together to form an insulating cap that substantially covers said end; and
wherein each of said plurality of insulating cap modules comprises at least one aperture that allows passage of said at least one projection there through when the modules are assembled.

17. The kit of claim 16, further comprising:
at least one side wrap; and
at least one airspace creating spacer configured to create dead air pockets between at least a portion of said heat source and said at least one side wrap.

18. The kit of claim 16, wherein said insulating cap comprises two insulating cap modules.

19. A method of making an insulating device, comprising:
creating an insulating device adapted for use with at least one heat source having at least one projection on an end thereof,
said insulating device comprising a plurality of insulating cap modules,
wherein said insulating cap modules assemble together to form an insulating cap that substantially covers said end; and
wherein each of said plurality of insulating cap modules comprise at least one aperture that allows passage of said at least one projection there through when assembled.

20. The method of claim 19, said insulating cap further comprising:
a body;
at least one flange member extending from said body;
poly-iso foam;
an airspace creating spacer disposed upon said insulating cap; and
at least one reflective surface on at least a portion of said insulating cap,
wherein said at least one heat source is at least one water heater, wherein said at least one aperture on each of said plurality of insulating cap modules align upon assembly; and
wherein said insulating cap is assembled from two insulating cap modules.
